(19) United States
(12) Patent Application Publication
(10) Pub. No.: US 2010/0057632 A1
(43) Pub. Date: Mar. 4, 2010

(54) Questionnaire research system

(76) Inventor: Emiko Kamano, Tokyo (JP)

Correspondence Address: Emiko Kamano, 4-6-33 Shibasaki-machi, Tachikawa-shi, Tokyo, 190-0023, JP

(21) Appl. No.: 12/462,339

(22) Filed: Aug. 3, 2009

Related U.S. Application Data
(62) Division of application No. 10/181,408, filed on Nov. 8, 2002.

(30) Foreign Application Priority Data
Jan. 31, 2000 (JP) 2000-61170
Apr. 10, 2000 (JP) 2000-145751
May 15, 2000 (JP) 2000-182259
Sep. 11, 2000 (JP) 2000-317207

(51) Int. Cl. G06Q 10/00; H04M 3/42; H04M 11/00

(52) U.S. Cl. 705/325; 455/414.1; 455/406

(57) ABSTRACT

A system in which questionnaire research through the Internet communication using a mobile telephone is made and the consideration for returning the questionnaire is given to the replier, characterized in that the consideration returning method may be the one in which charge of calls by the replier equivalent to the consideration can be paid by a third person or the one in which the portion of the charge of the calls by the replier, the user of the mobile telephone, for one month equivalent to the consideration is paid by a third person and the remainder is paid by the replier. A questionnaire system is characterized by comprising auction means by means of which a questionnaire about things that a questionnaire making person feels daily is made, the answers are auctioned, and the reward obtained by the auction is returned to the questionnaire making person and replier.

### FIELD OF THE INVENTION

The present invention relates to a questionnaire research system (questionnairing system) wherein a questionnaire is executed through an internet communication by mobile telephones (portable telephones) and the telephone fees are paid by a questionnaire research company (questionnairing company).

Further, the present invention relates to a questionnairing system wherein a result of the questionnaire is sold by an auction and a compensation for the auction is divided among the people who set the questionnaire and the questionnaire repliers (people who answer the questionnaire).

### BACKGROUND ART

Conventional questionnairings are conducted by interviews on streets or visits of interview, or telephone calls.

However, it is not pleasant for the people to be curbed during the questionnairing. Further, they may not often afford time to answer sudden questionnairing without previous notices.

Therefore, it takes much efforts to get a lot of answers to the questionnaire.

Further, the answers may become ambiguous, when a degree of concern is neglected during the questionnairing. Quetionnairing result including such ambiguous answers is not accurate.

Furthermore, the answers are not classified easily in a short period of time in the conventional questionnairing. Therefore, in the modern world where the tastes of consumers change day by day, the questionnairing results are not always being utilized effectively, due to the time lag caused by the delayed completion of answer classification.

The present invention dissolves those disadvantages.

### DISCLOSURE OF THE INVENTION

The present invention is a questionnairing system wherein the people who replied the questionnairing through an internet communication by portable telephones are rewarded by compensation. In a first questionnairing system for rewarding compensation, accounting telephone numbers and maximum calls are previously registered in order to account the fee to a third party, and the accounting services to the third party are received at previously specified number designated by each user of the portable telephones.

In a second questionnairing system for rewarding compensation, accounting telephone numbers and maximum calls are previously registered, the portable telephone users pay every month the fee subtracted by the questionnairing compensation, the third party pays every month the questionnairing compensation, and reliability of the answer to the questionnairing is checked by check means.

Further, the questionnairing system of the present invention comprises: questionnaire registering means for arbitrary person to make, register and open to the public a questionnaire concerning his or her concerns; and answerer registering means for previously registering the people who answer the questionnaire; auctioning means for auctioning a result of the questionnairing and rewarding to the questionnaire maker and the questionnaire answerers the compensation obtained by the auction.

Further, the questionnairing system of the present invention may further comprises answerer identification means for inputting: a questionnaire identification number issued by a store who serviced the answerer; service data issued by the store; and data identifying the portable telephone number of the answerer. It becomes possible to improve correctness of the answers to the questionnaire and to grasp exactly consumer needs.

### BRIEF DESCRIPTION OF THE DRAWINGS

FIG. 1 is a block diagram of a first embodiment of the present invention.

FIG. 2 is a flow chart of a first example of the questionnairing.

FIG. 3 is a flow chart of an example of a telephone call by using a third party accounting in the questionnairing system of the present invention.

FIG. 4 is a block diagram of a second embodiment of the present invention.

FIG. 5 is a flow chart of a second example of the questionnairing.

FIG. 6 is a flow chart of an example of a telephone call by another third party accounting in the questionnairing system of the present invention.

FIG. 7 is a flow chart of an example of the auction.

FIG. 8 shows an embodiment of specific answerer identifying means.

FIG. 9 is a flow chart for explaining the entire operation of the specific answerer identifying means.

FIG. 10 is a flow chart for explaining a method for identifying the answerers by using the specific answerer identifying means.

### BEST MODE FOR CARRYING OUT THE INVENTION

Embodiments of the present invention are explained.

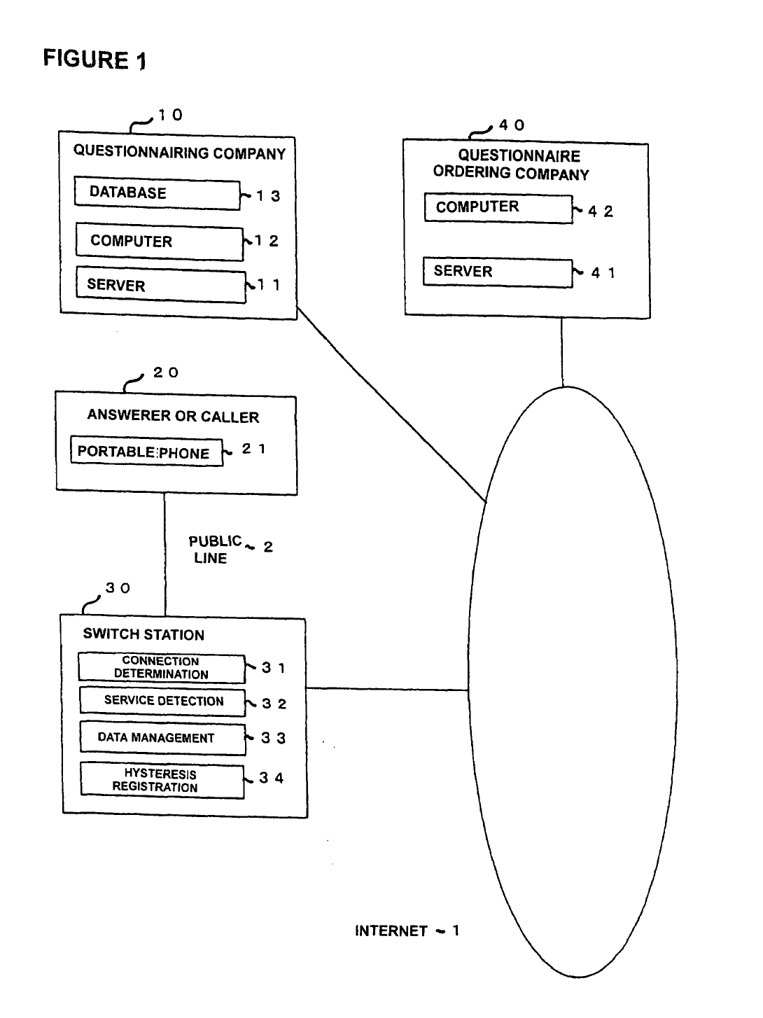

FIG. 1 is a block diagram of a first embodiment of the present invention.

In the questionnairing system, questionnairing company 10, switch station 30, questionnaire ordering company 40 and questionnaire answerer 20 are connected with internet 1.

Questionnairing company 10 comprises server 11, computer 12 and database 13.

Switch station 30 is a control system for controlling public telephone network including exchange apparatus. Switch station 30 comprises connection determination unit 31, service detection unit 32, data management unit 33 and utilization hysteresis registration unit 34.

Questionnaire ordering company 40 comprises server 41 and computer 42.

Questionnaire answerer comprises portable telephone 21.

Further, each element is explained in detail.

Database 13 in questionnairing company 10 stores all of the questionnaires which are being conducted.

Data of the answers to the questionnaires are classified on the real time basis by computer 12 and are stored in database 13. Switch station 30 comprises: service detection unit 32 which detects accounting (third party accounting) request by questionnairing company 10 from caller portable telephone 21; connection determination unit 31 by which calling answerer 20 determines whether or not the third party accounting service is available; data management unit 33 which manages the data referred to during the determination of connection determination unit 31; utilization hysteresis registration unit 34 which holds the communication service hysteresis in order to charge telephone call fee and to notify the caller of particulars of the call.

Data management unit 33 updates data on the basis of data update request transmitted through internet 1 by questionnairing company 10.

Switch station 30 detects a request of the third party accounting by using service detection unit 32, when it receives a connection request from calling answerer 20 who has a previously designated specific number such as 0188.

Further, connection determination unit 31 connects the calling terminal with the called terminal, when it determined that the telephone number of the caller is listed in data management unit 33, thereby executing the third party accounting.

Further, data management unit 33 also stores maximum available call measure.

When the maximum available call measure may soon be attained, the caller is warned by warning sound and so on. Further, when the maximum available call measure is used up, the third party accounting is switched into caller accounting, or the call is forced to be cut off.

A series of communication hysteresis according to the above-mentioned procedures are stores in utilization hysteresis registration unit 34.

Switch station 30 charges the account to the third party and notifies the third party of the particulars of calls, by using internet 1, on the basis of the data stored in utilization hysteresis registration unit 34.

Questionnaire ordering company 40 orders a necessary questionnaire to questionnairing company 10 and obtains the questionnaire result.

Questionnaire answerer 20 answers the questionnaire selected through internet 1, by connecting portable telephone 21 with questionnairing company 10.

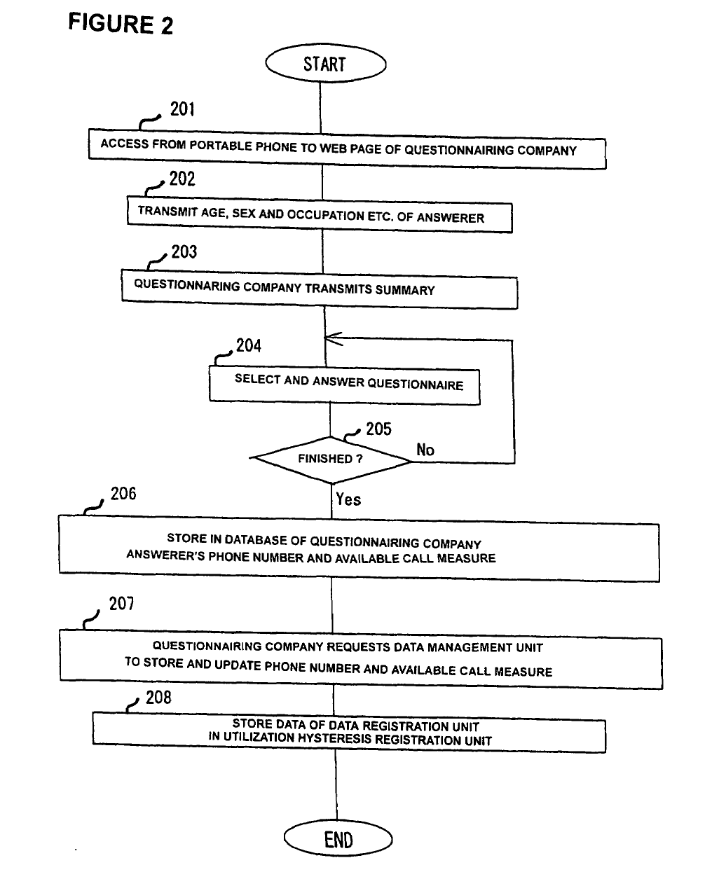

Next, a first example of the questionnairing is explained in detail, referring to the flow chart as shown in FIG. 2.

Calling answerer 20 accesses a web page of the questionnaire by using portable telephone 21 through an internet communication service exclusively provided to portable telephone such as NTT “i” mode (STEP 201).

Calling answerer 20 inputs his or her age, sex, occupation (STEP 202).

Questionnairing company 10 reads out, on the basis of the conditions including the telephone number of the calling answerer, one or more questionnaires stored in database 13 which may be answerable by that calling answerer 20 and transmits a summary of the read-out questionnaire (STEP 203). The questionnaire summary may include name of the questionnaire, time required to answer and a reward for answerers.

Calling answerer 20 selects a questionnaire of his or her concern to have the selected questionnaire be sent to him or her. Then, answerer 20 answers his or her answers (STEP 204).

After completing answering, the telephone connection is cut off (STEP 205).

Next, the telephone number of the calling answerer 20 and newly generated telephone call measure due to the answering are stored in database 13 (STEP 206).

Data update is requested through internet 1 to data management unit 33 in switch station 30 in order to update data (STEP 207).

The data updated by data management unit 33 is stored in utilization hysteresis registration unit 34, on the real time basis (STEP 208).

Further, the questionnaire answer data is accumulated by computer 12 and the accumulated data is stored in database 13.

Thus, the questionnaire result data is transmitted through internet 1 to questionnaire ordering company 40.

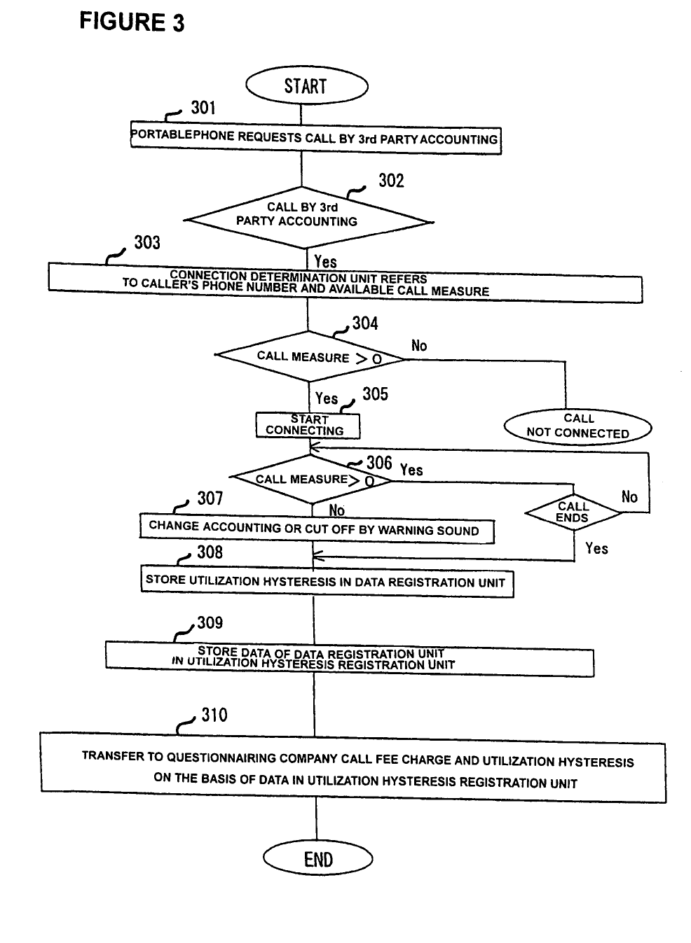

Next, an example of a telephone call by using a third party accounting is explained, referring to the flow chart as shown in FIG. 3.

The third party accounting service is utilized by portable telephone 21 by using a previously designated specific telephone number such as 0188 (STEP 301). Then, after detecting the third party accounting request in service detection unit 32 in switch station 30 (STEP 302), connection determination unit 31 confirms that the telephone number and maximum available measure of the caller are registered in data management unit 33 (STEP 303). Then, after the confirmation, the calling terminal is connected with the called terminal (STEP 305). Further, when the maximum available call measure may soon be attained, the caller is warned by connection determination unit 31 by using warning sound and so on, and when the maximum available call measure is used up, the third party accounting is switched into the caller accounting, or the call is forced to be cut off, by connection determination unit 31 (STEP 307).

A series of communication hysteresis is stored in data management unit 33 (STEP 308).

After completing calling, the data updated by data management unit 33 is stored in utilization hysteresis registration unit 34 (STEP 309).

Switch station 30 transfers the charged telephone fee and the service utilization hysteresis through internet 1 to questionnaire company 10 (STEP 310).

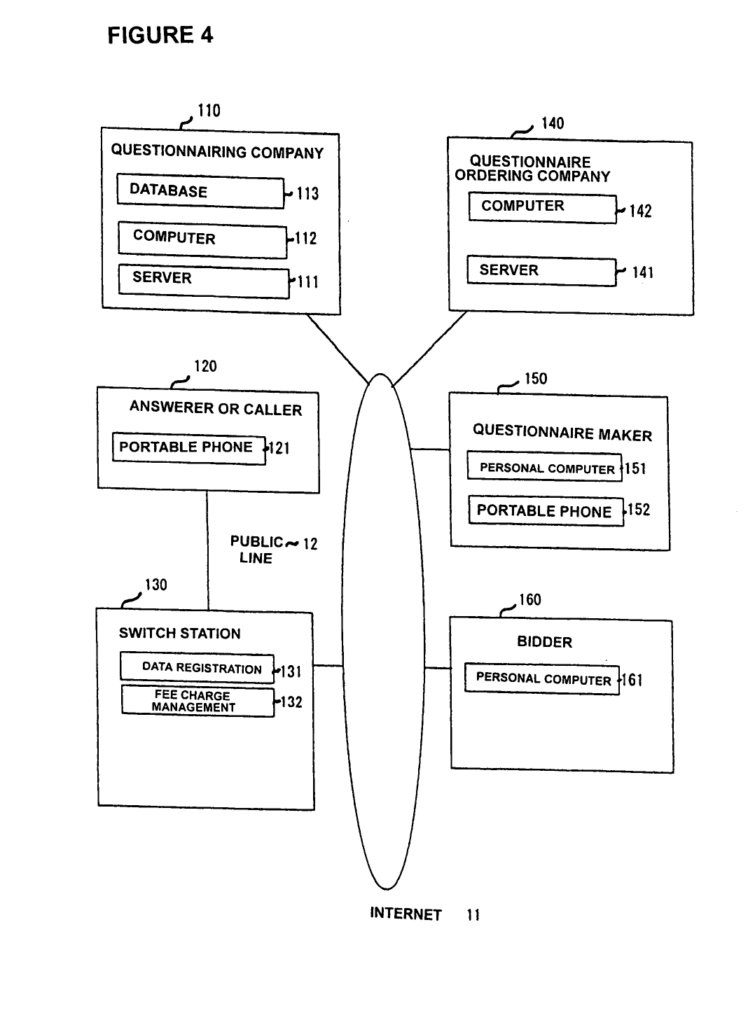

Next, a second embodiment of the questionnairing system of the present invention is explained, referring to the block diagram as shown in FIG. 4. In the second embodiment, a monthly telephone fee charge reflecting the reward to the answering is newly introduced in switch station and an auction is also newly introduced, compared with the first embodiment as shown in FIG. 1.

In the questionnairing system, questionnairing company 110, switch station 130, questionnaire research order company (questionnaire ordering company) 140, person who makes questionnaire (questionnaire maker) 150, questionnaire replier (answerer to questionnaire) 120 and bidder (auction participant) 160 are connected by internet 1.

Questionnairing company 110 comprises server 111, computer 112 and database 113.

Switch station 130 is a control system for controlling public telephone network including exchange apparatus. Exchange (Switch station) 130 comprises data registration function unit (data registration unit) 131 and charging managing function unit (telephone fee charge management unit) 132.

Questionnaire ordering company 140 comprises server 141 and computer 142.

Questionnaire maker 150 comprises computer 151, or portable telephone 152.

Questionnaire answerer comprises portable telephone 121.

Further, each element is explained in detail.

Database 113 in questionnairing company 110 stores all of the questionnaires which are being conducted. The questionnaire to answerers is issued by computer 112.

Data of the answers to the questionnaires are classified on the real time basis by computer 112 and are stored in database 113. The data of the answerers is also stored in database 113.

Further, a web page of the questionnairing system of the present invention stored in server 111 in questionnairing company 110 is accessible from outside. Registration and auction of questionnaire are executed by using that web page.

Switch station 130 comprises: data registration unit 131 which receives and stores the telephone numbers used for the third party accounting and telephone call measure due to the answering; and telephone fee management unit 132 which charges a telephone call fee, on the basis of the data stored in data registration unit 131.

Data registration unit 131 updates the data, on the basis of the data registration request transmitted through internet 11 by questionnairing company 110.

Through internet 11 and public telephone network 12, switch station 30 charges the telephone call fee on the third party and the user of portable telephone and notify them of the particulars of the telephone calls.

Questionnaire ordering company 140 accesses the web page of questionnairing company 110 and registers the order of the necessary questionnaire and obtains the questionnaire result.

Questionnaire maker 150 accesses the web page of questionnairing company 110, by using portable telephone 151 or computer 152 and registers questionnaire problems.

Questionnaire answerer 120 answers at his or her leisure time the questionnaire of his or her concern selected through internet 11, by connecting portable telephone 121 with questionnairing company 110.

Auction anticipant 160 selects and anticipates an auction on the web page of the questionnairing company.

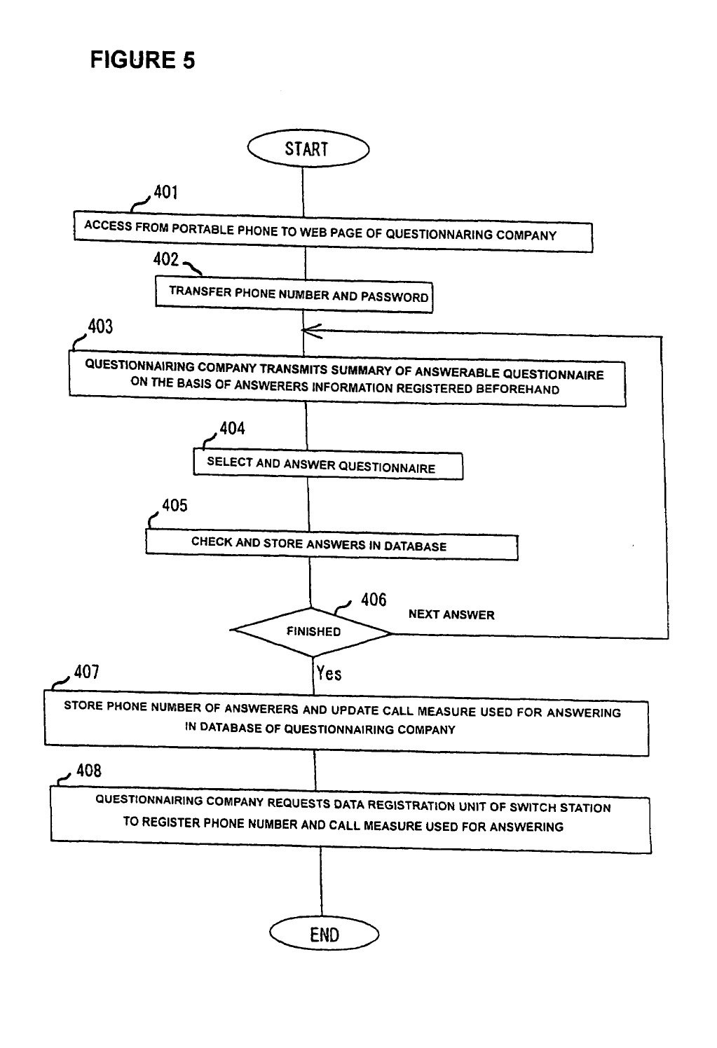

Next, an example of the questionnairing is explained in detail, referring to the flow chart as shown in FIG. 5.

Answerer 20 first obtains his or her password, by registering in the questionnairing company his or her telephone number, distinction of sex, date of birth, occupation and so on. Next, calling answerer 120 accesses the web page of the questionnaire by using such an internet communication as NTT “i” mode (Step 401).

Calling answerer 120 input his or her telephone number and password (STEP 402).

Questionnairing company 110 reads out, on the basis of the conditions including the telephone number of the calling answerer, refers to the information of the answerers registered beforehand, in order to pick up the questionnaires which satisfy that information as well as the questionnaire conditions. Then, a summary of questionnaire which may be answerable by answerer 120 is transmitted (STEP 403). The questionnaire summary may include name of the questionnaire, time required to answer and a reward for answerers.

At this point of time, the questionnairing company receives the domain name in the communication command of the portable telephone and can confirm that it receives the call connection from a portable telephone, thereby effectively identifying the answerer. For example, if the domain name is not being registered beforehand, the call is determined to be of a wrong purpose and is cut off.

Calling answerer 120 selects a questionnaire of his or her concern in order to have the selected questionnaire be sent to him or her. Then, answerer 120 answers his or her answers (STEP 404).

After completing answering, the telephone connection is cut off (STEP 406).

At this point of time of questionnaire finishing, the web page of the questionnaire ordering company may be displayed in order to get a link from the answerers.

This is implemented merely by adding link address to the displaying page.

Further, confirmation question such as “What is your month of birth?, November, December, or January?” is added, thereby ensuring an accuracy of the questionnaire when the confirmation question is answered correctly. On the other hand, the corresponding answers to the questionnaire are invalidated, when the confirmation question is not answered correctly.

Further, the frequency of the confirmation question may be varied, by storing the answer hysteresis in database 113. For example, one confirmation question may be imposed every 10 questionnaires, when the effective answer is greater than 90%, while two confirmation questions may be imposed every questionnaire, when the effective answer is less than 30%. Furthermore, the invalidated answering may be excluded from the third party accounting (STEP 405).

After completing the answering in accordance with the above-mentioned procedures, the telephone measure due to the answering as well as the telephone number are stored in database 113 (STEP 407).

The answer data is accumulated successively and the database 113 is updated by the accumulated result.

The questionnaire result thus accumulated is sent through internet 11 to questionnaire ordering company 140.

Owing to the above-explained procedures, overlapped answer by the same person can be avoided, due to the identification of the telephone number. And the accuracy of the questionnaire can be ensured by the confirmation question.

Questionnairing company 110 accumulates the telephone call measure due to the questionnaire answering every month or for a prescribed period of time and requests the data registration by accessing data registration unit 131, thereby updating registered data (STEP 408).

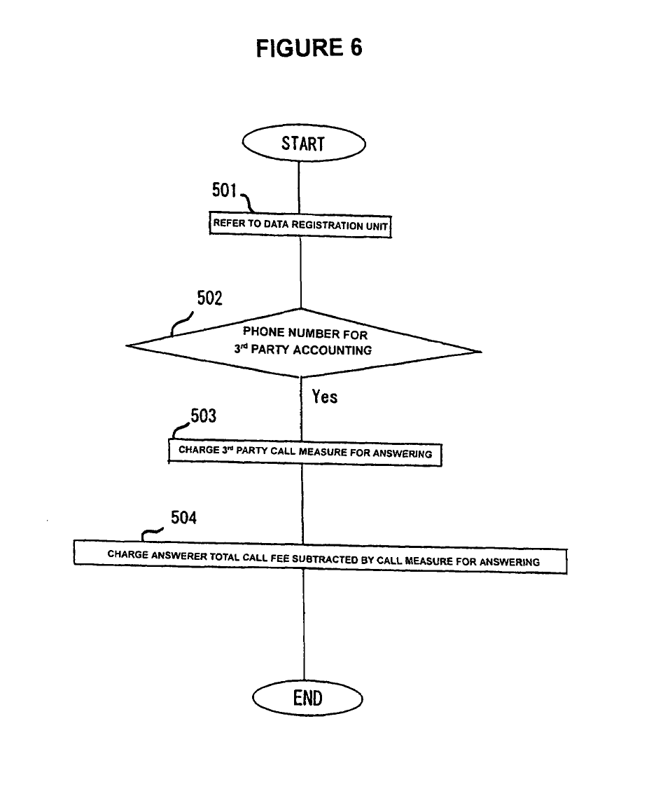

Next, an exemplary system for a telephone call fee accounting is explained, referring to FIG. 6.

Data registration unit 131 is referred to, when accumulating telephone call fee during a month or a prescribed time period (STEP 501). Further, it is checked whether the telephone number is registered for the third party accounting (STEP 502). If the telephone number is registered for the third party accounting, the telephone call fee is charged to the third party (STEP 503). Then, the user of the portable telephone is charged with the total fee subtracted by the fee charged to the third party (STEP 504).

If the fee charged to the third party surpasses the total fee, the third party may pay the total fee. The surplus may be cleared once or be reserved for the next payment.

Alternatively, the maximum telephone call measure may be prescribed, thereby excluding any answer over the maximum measure.

The charge to the third party is transferred through internet 11 together with the registered data.

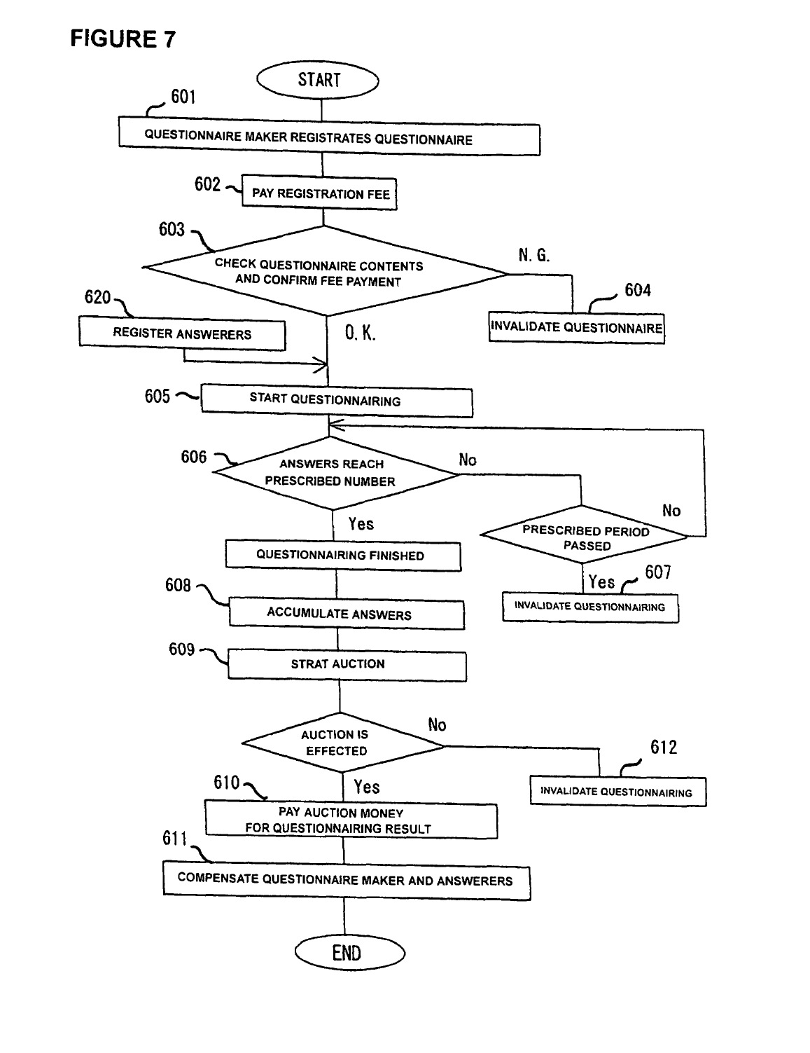

Next, an exemplary auction is explained, referring to the flow chart as shown in FIG. 7.

The questionnaire registration means includes: means by which questionnaire maker pays a registration fee in order to register his or her questionnaire; and means by which the questionnairing company checks the contents of the questionnaire.

First, the questionnaire maker accesses the web page of the questionnairing company, thereby inputting the questionnaire in accordance with the prescribed format. The questionnaire is transmitted after completing the input (STEP 601). The input format is defined, for example, by title, object, problems, choices, condition to answerer, necessary number of answers and bank account for transferring the compensation for answering and so on.

The questionnaire maker shall pay the registration fee, at the same time when he or her submits the questionnaire (STEP 602). The cash for the payment may be transferred to a designated bank account. Further, the transferring procedure to the accounts of several banks is possible through the internet.

Alternatively, a payment in advance for the registration fee at the time when submitting the questionnaire may be employed, by transferring cash from a bank account of the questionnaire maker opened beforehand to a bank account of the questionnairing company exclusively used for the questionnaire submitting. The acceptance of the submitted questionnaire become rapid by the payment in advance, thereby starting the questionnairing soon after the questionnaire acceptance.

Here, the questionnaire registration is possible by personal computer 122 or portable telephone 121.

The questionnaire received by the questionnairing company is store in database 113 temporarily and the contents thereof are checked (STEP 603), thereby invalidating questionnaires which includes such slander, malice which does not deserve opening to public (STEP 604).

Next, the checked questionnaire is registered in database 113 in use for questionnaire transmission, after completing the payment of the registration fee, thereby starting the questionnairing immediately (STEP 605).

Questionnairing continues for a prescribed time period, unless the answers reach the prescribed number (STEP 606). The questionnairing is invalidated, when the answers do not reach the prescribed number even after passing the prescribed time period (STEP 607). The effective questionnaire is accumulated (STEP 608).

Alternatively, the questionnairing may be executed for the prescribed time period without limitation of the prescribed number of answers. In this method, the greater is number of answers in a definite period, the higher are social concerns. Therefor, the questionnairing result by this method indicates a value of information of the questionnairing result.

Next, answerer registration means is explained.

When answerer 130 obtains his or her password by mailing the questionnairing company, answerer registration means transmits information of answerer 130 as telephone number, distinction of sex, date of birth, address, occupation and bank account for receiving the compensation in the auction. Then, questionnairing company registers the mail address and password of the portable phone and the information of the answerer (STEP 620).

Concretely, the portable telephone transmits to the questionnairing company a mail for requesting a password, thereby obtaining the password in return. Next, answerer 130 accesses the web page of the questionnairing company by using an internet communication exclusively used for portable telephones such as NTT “i” mode. Next, after inputting the password, the above-mentioned information of the answerer is inputted. Due to this procedures, the questionnairing company registers an information set including the mail address, the password and the information of the answerer. Thus, it becomes possible to answer the questionnaire.

The advantages of mail transmission are to recognize a precise proper address of the answerer's portable telephone and to confirm the domain name by using the mail address. If the domain name does not belong to the portable telephone of the answerer, such an access is incorrect and is rejected.

Next, the questionnaire answering is explained.

Answerer 130 accesses at his or her leisure time the web page exclusively used for questionnaire answering in order to input the password and the date of birth which is a part of information of answerer.

Questionnairing company 110 confirms the calling answerer, referring to database 113, on the basis of inputted password and date of birth. Then, the questionnaire compatible with the questionnairing conditions is picked up from database 113, on the basis of the information of the answerer.

Here, the questionnairing conditions are limitations such as an age, occupation and so on of the answerer. Then, summaries of one or more questionnaires which may be answerable for answerer 130 are transmitted to answerer 130. Here, the summary of questionnaire includes a title, problems and so on.

When answerer 130 selects a questionnaire of his or her concern, the text of the selected questionnaire is sent. Then, the answer is sent back. After completing answering the questionnaire, the telephone call is cut off. Thus, the questionnairing is finished.

Next, the auction means is explained.

The auction means executes an auction of accumulated questionnaires, pays compensations for questionnaire makers and answerers.

A web page for auction for opening contents of questionnaires is provided in a web page of the questionnairing company, thereby executing the auction (STEP 609). The contents of questionnaire includes the contents described by the questionnaire maker at the time of the registration of the questionnaire, time period for questionnairing, number of problems and so on. Needless to say, a questionnaire result is opened only to the winner of the auction.

When an auction has been concluded, the questionnairing result is delivered through the internet (STEP 610), while the auction conclusion money is paid to the questionnaire makers and answerers (STEP 611). The payment may be executed by transferring cash to bank accounts opened beforehand.

In place of bank account transfer, the telephone call measure may be compensated, as explained above.

When the auction is not concluded, the auctioned questionnaire is invalidated (STEP 612). Further, concerning the questionnaire invalidated due to this and other reasons, the questionnaire makers and answerers do not get in principle, any compensation.

An exemplary application procedure of auction is explained in brief. The questionnaires by which auctions are being under way are classified and displayed on the web page. Every bidder selects an auction of his or her concern and inputs an auction money and mail address. The person who presents the money highest at the prescribed time of the end of the auction is an auction winner. The auction winner pays the auction money in exchange for obtaining the questionnairing result. Thus, the auction is finished.

Here, an alternative way of delivering the questionnaire result is to transmit a key for cryptography, thereby browsing various results by using data analysis software loaded on the web page.

The above-explained questionnairing is finished in a short period of time on the internet. Therefore, the questionnairing system of the present invention is effective for grasping market needs, from a point of view of grasping current and alive information.

Although an object of conventional questionnairings is to adapt a certain commodity to consumer needs, an object of the present invention is to auction a questionnairing result of questionnaire of concern of a lot of consumers who feel various problems and inconveniences every day. And business managers concerning the questionnaire contents may possibly create a new business chance.

Further, although the conventional auctions are valuable for tangible things such as commodities, the present invention is characterized by its value for intangible information such as consumer heeds.

Next, a particular example of the answerer identification means in the questionnairing by the portable telephone, wherein impressions of stores such as a supermarket are inquired.

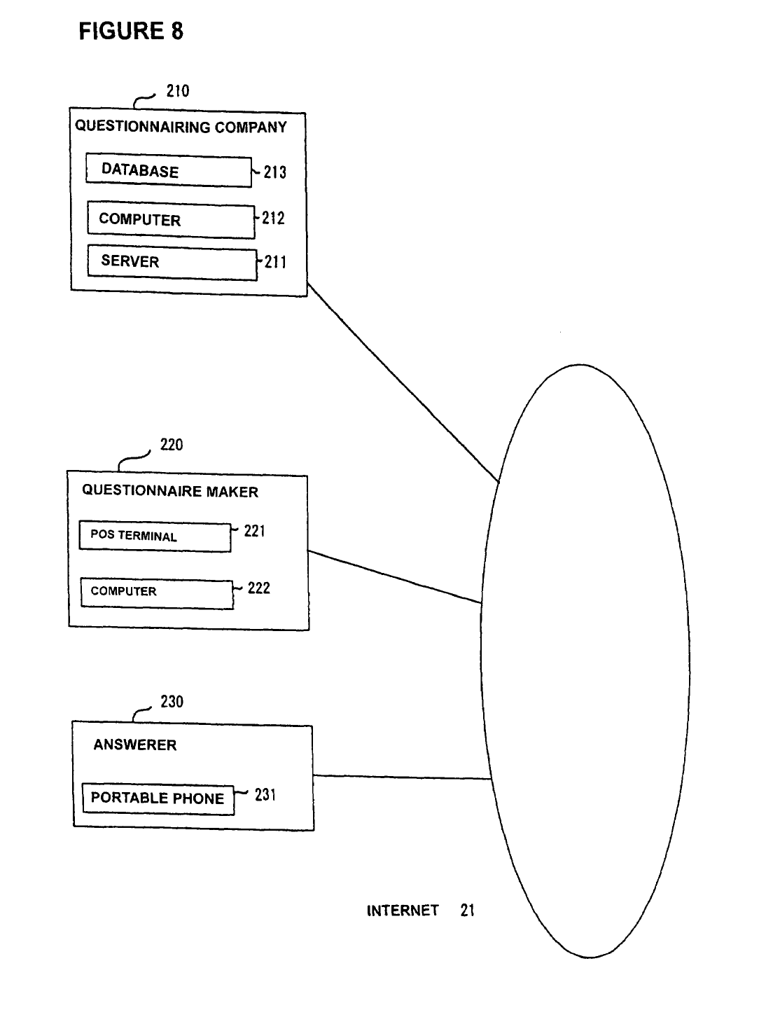

FIG. 8 is a block diagram of the embodiment of the present invention.

In the questionnairing system, questionnairing company 210, questionnaire maker 220 and questionnaire answerer 230 are connected with internet 21.

Questionnairing company 210 comprises server 211, computer 212 and database 213.

Questionnaire maker 220 comprises POS terminal 221 and computer 222.

Questionnaire answerer 230 comprises portable telephone 231.

Further, each element is explained in detail.

Server 211 provided with a web page for questionnaire registration and a web page for questionnaire answering in questionnairing company 210 is accessible through the internet. The questionnaires under way at present are stored in database 213. Questionnaires to the answerers are issued by computer 12. Further, information of the answerers is stored in database 213.

Further, the answers to the questionnaire are accumulated on the real time basis and is stored in database 213.

Questionnaire maker 220 uses computer 222 in order to access the questionnaire registration web page of the questionnairing company for registering his or her questionnaire.

Further, receipts issued by the POS terminal is stored in computer 222 and only the information for identifying answerers included in the receipt data is transmitted to the questionnairing company.

Questionnaire answerer 230 answers the questionnaire by connecting portable telephone 221 with questionnairing company 210.

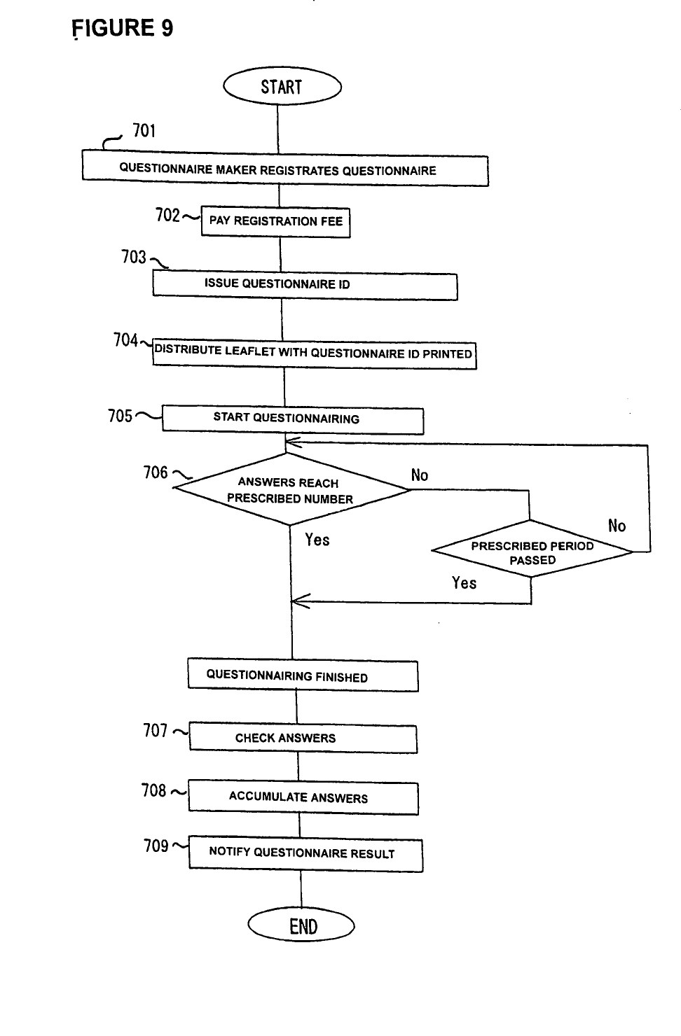

Next, an entire process of the particular example of the present invention is explained in detail, referring to the flow chart as shown in FIG. 9.

Questionnaire maker 220 executes questionnaire registration by paying a registration fee and transmitting the questionnaire made by him or her (STEP 701).

The questionnaire maker 220 shall pay the registration fee, at the same time when he or she transmits the questionnaire (STEP 702).

The questionnaire received by the questionnairing company is stored in database 213 temporarily. The received questionnaire is registered in database 213, after confirming the fee payment. The questionnairing is started at a prescribed time (STEP 705).

Questionnairing company issues the questionnaire identification number to questionnaire maker (STEP 703). The questionnaire maker notifies customers of the questionnaire ID number at the prescribed time. The questionnaire ID number may be notified, for example, by distributing a paper with the ID number printed on it (STEP 704). Further, there are described on the paper a request for an answer to the questionnaire and an explanation of the answering procedure.

Next, the answering procedure by which answerers who got the paper or leaflet at the store answer the questionnaire is explained. An example thereof is described. Answerer 230 accesses the questionnaire answering web page by using the portable telephone, thereby inputting the questionnaire ID number printed on the distributed paper, the data printed on the receipt issued by the store and the data for identifying the portable telephone number.

Here, the data printed on the receipt is a data for identifying that receipt such as a pair of a receipt number and a time when that receipt was issued, or a pair of a receipt number and a total payment. Although data sufficient enough to identify the receipt is necessary, specific kind of data is not required.

Further, the data for identifying the portable telephone number may include its telephone number, or its mail address.

Then, the questionnairing is executed.

The questionnairing may be executed during a prescribed time period. Alternatively, the questionnairing may be completed, when the answers reaches a prescribed number (STEP 706).

After completing questionnairing, the answers are checked (STEP 707). The answer checking is explained in detail, hereinafter.

A procedure which improves a reliability of the answer data is explained. The information for identifying the answerer is selected among the data printed on a receipt and is transmitted through the internet to the questionnairing company. The information for identifying the answerer may be a receipt number and receipt issue time, as mentioned above.

The questionnairing company stores the information for identifying the answerers, thereby invalidating an answer, when there is not correct correlation between questionnaire ID number, receipt data and portable telephone identifying data.

Further, the correlation confirmation method is explained in detail. First, the store is identified by the questionnaire ID number. Next, the receipt is identified by confirming a coincidence of the POS data transmitted from the identified store with the receipt data in the questionnaire answer. Therefore, an answer shall be effective, when the POS data is consistent with the answer data. Otherwise, the answer shall be invalidated.

Determination of the consistency of the POS data with the answer data is explained. For example, an answer is invalidated, when a customer went to a store but did not buy anything. In this case, there is no receipt data in the answer. An answer is invalidated, even if only the receipt data is inputted. In this case, the store is not identified. The questionnaire ID number and the receipt data prove the fact that the answerer went to the store concerning the questionnaire, that the answerer got the questionnaire ID number, and that the answerer got the receipt.

In this manner, the present invention takes into consideration the factor that any person who did not actually go to the store and/or did not buy any thing can not qualified to answer the questionnaire, if at least two kinds of data such as the questionnaire ID number and the receipt data distributed at the store.

The answerers are also identified by checking the telephone number identifying data inputted by the answerers. Such identification makes it possible to exclude multiple answers, when only one answer is permitted to an answerer. Therefore, for example, a plurality of receipts issued by a store is invalid, because the telephone number is identical in an arbitrary questionnaire ID number. The storage of the telephone number identifying data is useful for paying compensations to the answerers. In this case, the compensation payment may be executed for the telephone call fee every month.

Further, the answerer may use its mail address in place of its telephone number, by transmitting to the questionnairing company a mail by the mail function of the portable telephone. An advantage of using the mail address is that erroneous input of the telephone number is avoided.

Thus, only the effective answers are accumulated by checking the answers in accordance with the above-mentioned procedure (STEP 709).

The above-mentioned questionnairing is finished in a short period of time through the internet, thereby analyzing during a day the questionnaire result executed in that day and grasping the market needs.

The above-mentioned system is characterized in that any investment for software and hardware is not required for the questionnairing.

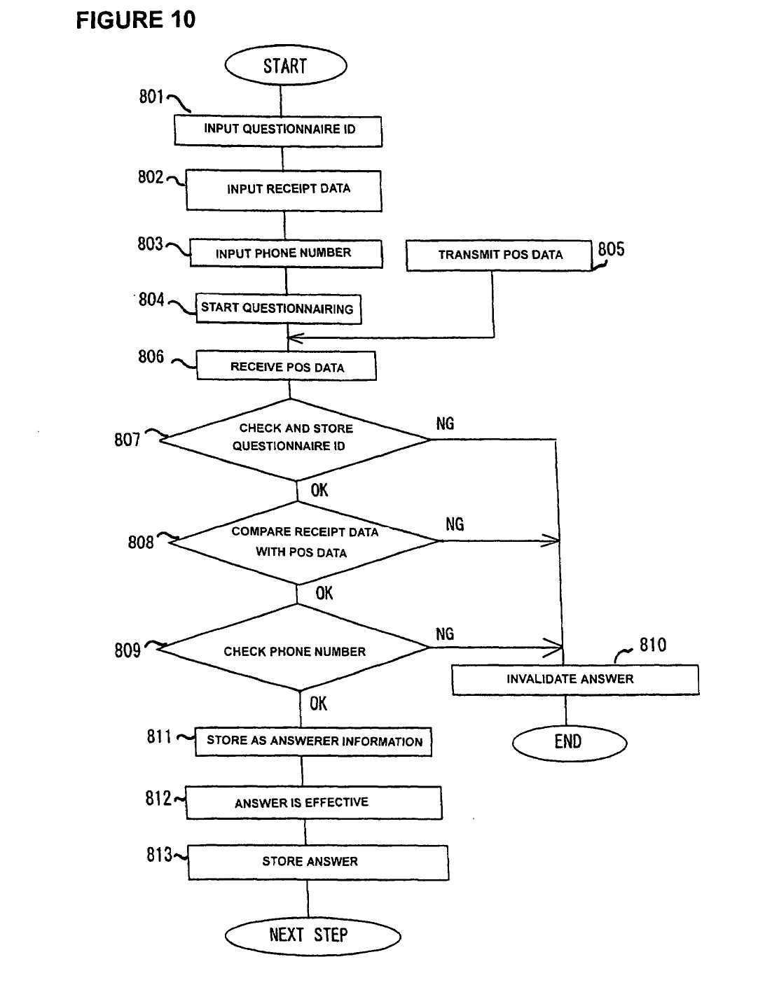

Finally, an example of the answerer identification means is explained, referring to the flow chart as shown in FIG. 10.

First, the answerer accesses the web page for questionnaire answering in order to input the questionnaire ID number described on the paper distributed in the store (STEP 801), then to input the receipt data such as the receipt number or issued time described on the receipt issued by the store (STEP 802), and to input the portable telephone identifying data such as the telephone number (STEP 803). Then, the answerer inputs a series of answers to the questionnaire problems (STEP 804).

On the other hand, the questionnaire maker transmits to the questionnairing company the answerer identifying data selected among the POS data (STEP 805).

The questionnairing company receives the POS data and stores it in database (STEP 806) and then, confirms every answer data as follows:

First, the questionnaire ID number is checked in order to determine that the ID number is the same number as issued by the questionnairing company (STEP 807). Next, it is determined whether or not the POS data transmitted from the store using that ID number is consistent with the receipt data inputted by the answerer (STEP 808). Next, it is determined whether or not the telephone number inputted by the answerer has been already registered (STEP 809). The answer is deemed effective, when the telephone number is newly registered. On the other hand, when the telephone number has been already registered, it is determined whether or not the last ID number is different from the ID number at this time. When the last ID number is the same as the ID number at this time, the present answer is deemed not effective, because it is an overlapped answer (STEP 810).

After completing the above-explained checking, the effective answers are stored in the database (STEP 811) and accumulated (STEP 813). The similar procedures are applied to the questionnaire henceforward.

The above-explained example may be applied not only to a retail store such as a super market, but also any organization who issues a receipt for its service such as a restaurant and beauty salon.

The present invention is not limited to the embodiment thus far explained, but also a system wherein the switch stations of the portable telephones and the questionnairing company are connected each other by leased communication channels, thereby improving information security and identification management of the answerers.

Further, the telephone call fee accounting including the questionnaire compensation may be executed by a special purpose company in place of the switch station, thereby implementing a more efficient system suitable for reflecting the user needs.

Further, the present invention is not limited to the conventional portable telephone, but also applicable to new portable terminals with similar functions.

Further, the present invention is not limited to the examples as shown in the drawings.

Further, the present invention is not limited to the portable telephone, but is also applicable to a personal computer and web TV.

Furthermore, the present invention is not limited to the questionnairing, but also applicable to a system wherein the portable telephones transmit useful information to a specific server.

### INDUSTRIAL APPLICABILITY

According to the present invention which is completely different from conventional questionnairing, the answerers can select a questionnaire of their concerns and answer it at their leisure time. Therefore, the questionnaires become more familiar. Accordingly, the user's opinions are picked up more correctly, thereby, for example, balancing supply and demand in manufacturing commodities.

Further, according to the present invention, a new business construction or reconstruction is possible by effectively utilizing a questionnaire result including points raised by the consumers.

Further, according to the present invention, a rapid and cheap questionnairing can be executed without special facility investment. Particularly, it becomes possible to grasp consumer needs changing day by day. Therefore, it is avoidable that the manufacturers notice the change of the consumer needs and sustains a great damage, only when the consumers are gone away.

1-21. (canceled)

22-26. (canceled)

27. A questionnairing system for executing a questionnaire by portable terminals which are connected to a subscriber telephone line, through a digital data communication including an internet communication, and for registering a information of answerer in a computer of a questionnairing company that is executing said questionnairing system, said questionnairing system comprising:
answerer registration means for said computer of said questionnairing company saving said information of answerer that are received by said portable terminals:
checking means for ensuring a reliability of a questionnairing; wherein said checking means comprising:
inserting means for inserting at random a plurality of confirmation questions that are making from said information of answerer in said answerer registration;
validating means for validating corresponding answers to said questionnaire if said confirmation question is answered correctly, that answer is checked with said information of answerer in said answerer registration, and invalidating said corresponding answers to said questionnaire if said confirmation question is not answered correctly; and
storing means for storing an answer hysteresis to said confirmation questions, and varies a frequency of inserting said confirmation questions in accordance with an effective rate of answering said confirmation questions; and
said computer of said questionnairing company comprises said answerer registration and said checking.

28. The questionnairing system according to claim 27, wherein said portable terminals are a portable telephone, a personal computer or a web TV, which are connected to a subscriber telephone line.

29. The questionnairing system according to claim 27, wherein said portable terminals are connected through leased channels with said questionnairing company.

30-38. (canceled)
